(19) United States
(12) Patent Application Publication
(10) Pub. No.: US 2004/0002160 A1
(43) Pub. Date: Jan. 1, 2004

(54) Method and device for monitoring worker's exposure pattern at workplace

(75) Inventors: Tung-Sheng Shih, Taipe (TW); Peng-Yau Wang, Taipei (TW)

Correspondence Address: BACON & THOMAS, 4th Floor, 625 Slaters Lane, Alexandria, VA, 22314, US

(73) Assignee: Institute of Occupational Safety and Health, Council of Labor Affairs, Shijr City (TW)

(21) Appl. No.: 10/179,252

(22) Filed: Jun. 26, 2002

(51) Int. Cl. G01N 23/00; G01N 1/22

(52) U.S. Cl. 436/57; 436/181; 436/164; 356/51

(57) ABSTRACT

A device is used to monitor a worker's exposure to a hazardous gas in a workplace. The device includes an infrared locating member, a chemical sensor, a controller, and a power source. The infrared locating member is used to monitor the worker's exposure position. The chemical sensor is uses to monitor the worker's exposure concentration. The controller serves as a central processing unit to receive an exposure position signal from the infrared locating member, and an exposure concentration signal from the chemical sensor. The controller is provided with a built-in or externally-connected timer.

### FIELD OF THE INVENTION

The present invention relates generally to the worker's exposure pattern at workplace, and more particularly to a method and a device for monitoring simultaneously the location, the time, and the quantity of exposure of a worker to a hazardous gas at workplace.

### BACKGROUND OF THE INVENTION

The assessment of exposure of workers to the harmful elements at workplace is an essential task of the occupational safety and healthy. Generally speaking, a comprehensive assessment should include the extent of exposure, the duration of exposure, the way by which exposure takes place, number of workers who are exposed, the characteristic of exposure, the nature of exposure, and the like.

The conventional methods for attaining the exposure assessment are grouped into the direct assessment method and the indirect assessment method. The advantages and the disadvantages of the direct and the indirect assessment methods are discussed hereinafter.

The direct assessment method involves the use of an exposure monitor, which is carried by a subject to sample a hazardous gas in a breathing zone of the subject for a period lasting several hours or days. An integrated exposure of the subject is then calculated on the basis of the sample so taken. Such an estimated exposure is in fact an integrated exposure, which is the result of integrating various environments and times. The sample is taken by the active sampling or the passive sampling, which involves the use of various absorbing media, such as silica gel, activated carbon, molecular sieves, porous polymer, and the like. The active sampling and the passive sampling are generally carried out in conjunction with the read-out instruments. The active sampling is carried out in such a manner that a pump probe is used to take a sample of the pollutant, and that the absorbing medium is used to absorb the pollutant sample. The active sampling is often used in the standard sampling analysis method. The passive sampling is based on the Fick's diffusion law such that no additional power is needed to sample the hazardous gas. The passive sampling is portable and simple to use. As far as the sampling effect on VOC_{S} of low concentration is concerned, there is little difference between the passive sampler and the active sampler of the activated carbon. It is therefore apparent that the passive sampler can be used to sample the low concentration environment. For further details, please refer to the reference literature, Hickey J. L., Bishop C. C., American Industrial Hygiene Association Journal, 42:264-267, 1981. There are certain read-out instruments, which may be used to take the sample of certain specific gases, such as NO₂, H₂S, CO, O₃, and the like. However, these read-out instruments are not suitable for sampling the worker's exposure in view of the fact that they are expensive and cumbersome. In 1988, the U.S. Environmental Protection Agency compiled information on samplers which were intended to take samples of various pollutants. According to the report (Leaderer, 1993), a variety of samplers were developed for taking sample individually and were tested in workplace. Such direct sampling mode has an advantage of taking a sample which is representative of the worker's actual exposure. However, the direct sampling is not economically feasible, especially in a situation calling for a large-scale exposure assessment. As a result, the exposure assessment is made on the basis of random samples and is therefore subject to doubt. In addition, the exposure fluctuation of the worker is not reflected in such exposure assessment. In other words, the direct assessment method should be used in conjunction with the worker's time-activity pattern.

The indirect assessment method is the so-called pattern method, which involves the use of the time-activity pattern record to assess the worker's exposure duration in various microenvironments. The pollutant concentration at a constant point in the microenvironments is measured so as to assess indirectly the worker's total exposure to the pollutant by suing the formula as follows:

$${E}_{i} = {\sum }_{j = 1}^{J} ( {C}_{j} \times {T}_{i j} ) , \qquad ( 2 \text{-} 1 )$$

1), in which E₁ stands for the integrated exposure of the worker “i” within a specified period of time; Cⱼ, pollutant concentration of the microenvironment j; Tᵢⱼ, time during which the worker “i” stayed in the microenvironment “j”; J, sum of microenvironments in which the worker “i” stayed within a specified period of time.

The indirect assessment method has an advantage that it is relatively easy to take samples at a constant point, and that it is not required to take sample of each worker, thereby resulting in a substantial reduction in cost. In other words, the indirect assessment method calls for the constant point measurement in areas which are representative of the workplace. In addition, the worker's time-activity data can be economically obtained in the form of questionnaire. The indirect assessment method is thus suitable for use in an exposure investigation involving a large number of workers. However, the indirect assessment method has its limitation. For example, the data obtained by the questionnaires are imprecise and unreliable. In addition, the constant point sampling can not be equated to a worker's exposure in view of the fact that the location of the constant point sampling may happen to be a distance away from a location at which the worker is actually exposed. In light of the nature of work that different workers perform, they seldom stay at the same location for the same duration or with the same frequency. For this reason, their exposures are different. Accordingly, their exposures can not be assessed entirely on the basis of the 8-hour sampling average.

A vinyl chloride monomer (VCM) exposure assessment was disclosed by Du et al. in 1996 (Du C. L., Chan C. C., Wang J. D., BULLETIN OF ENVITONMENTAL CONTAMINATION AND TOXICOLOGY, 56:534-542,1996). The VCM exposure assessment was made on the basis of the individual samples of 49 workers in conjunction with the samples taken at the constant points within the workplace, as well as the data of the time-activity pattern. The extent of the exposure of each worker was estimated directly and indirectly, with the result of r² being 0.47. according to the ozone exposure assessment made by Liu in 1993, the sample of each of 23 children was taken. In addition, the samples were simultaneously taken at the constant points of the inside and the outside of the children's home. Furthermore, the time-activity pattern was investigated. For more details, please refer to Liu L. J. S., Koutrakis P., Suh H. M. Mulik J. D., Burton R. M., ENVIRONMENTAL HEALTH PERSPECTIVES, 101:318-324,1993. The statistical analysis showed that the correlation was poor if the individual sample concentration was compared with the concentration of the constant point of the outdoors, with r²=0.30 (indoor) and r²=0.17 (outdoor). If the time-weighted concentration of the indoor measurement value and the time-activity pattern record were compared with the individual sample value, r² is only 0.35. If the assessment was made under the circumstance that 23 children were asked to stay indoors or in vicinity of their home 95% of the time of one day of their choice, r² is 0.76. This might be due to a smaller variation in the indoor concentration and a greater variation in the outdoor concentration. In the event that other information is not available, the environment questionnaire may be used to reach the assessment. The environment questionnaire is aimed at the exposure source, the exposure path, and the like. The rough estimation is made on the exposure degree, the mature of exposure, and the source of exposure. The environment questionnaire lacks a verifiable standard. The contents of the questionnaire must be verified to make sure of the design integrity of the questionnaire. In addition, the accuracy of the questionnaire response must be verified to avert any error or misunderstanding. As a result, the questionnaire can lead to only an estimation. For a more precise assessment of the exposure, the above-mentioned two methods must be used together. The biomarkers are recently used to assess the exposure. The application of biomarkers is in its infancy; nevertheless it must be supplemented by the measurement of the pollutant concentration.

Among the conventional exposure assessments, the widely-used passive sampler is based on the diffusion principle for measuring the exposure amount continuously for 8 hours. This method is simple and is used to measure only the sum of one day exposure, without identifying the exposure location and the extent of exposure. The read-out instruments may be used to measure the exposure concentration in a short period of time, they are incapable of identifying the exposure location and the nature of circumstances under which the workers are exposed. In addition, the excessively high time resolution often results in the difficulty of data analysis. In measuring the workplace environment, it is important to have information on the factor and the location of exposure. In the past, the video camera was used to understand the condition of the workplace. This is an expensive method. The questionnaire may be used but it is unreliable as discussed previously. In doing the research on the exposure, it is important to investigate the exposure location, the exposure time, and the exposure amount.

### SUMMARY OF THE INVENTION

One of the objectives of the present invention is to provide a method for monitoring the workers' exposure at the workplace.

It is another objective of the present invention to provide a device for monitoring the exposure of workers at the workplace.

It is still another objective of the present invention to provide a sampling device for monitoring the exposure of workers at the workplace.

It is still another objective of the present invention to provide a method for monitoring the exposure location, the exposure time and the exposure concentration of workers at the workplace.

It is still another objective of the present invention to provide a device for monitoring the exposure location, the exposure time and the exposure concentration of the workers at the workplace.

It is still another objective of the present invention to provide a sampling device for monitoring the exposure location, the exposure time and the exposure concentration of workers at the workplace.

The inventors of the present invention have developed an individual exposure assessment system comprising an infrared locator, a chemical sensor, and an electronic control device. The system is capable of locating precisely the worker in action, the nature of activity at the time of exposure, and the magnitude of exposure. The system is simple in construction, cost-effective, and portable. The system can be used in conjunction with computer for diagram display and statistical analysis. The present invention is capable of precision measurement of exposure concentration and exposure pattern. For the purpose of the measurement of the time-activity pattern, the inventors of the present invention disclose an infrared time-activity pattern recorder (ITAPR) for verifying the exposure duration and frequency of the high, the intermediate, and the low exposure areas. The concentration measurement is done by taking samples of various kinds of work and by taking the average exposure. This method is different from the conventional method in that the conventional method takes the 8-hr average concentration. The method of the present invention takes the sample of each of the work classifications at the workplace, thereby identifying the average exposure concentration and the variation scope of the breathing zone of each work classification. The precise assessment is thus made on the basis of the precise time-activity pattern obtained by ETAP. This method enables one to know the exposure duration and frequency of each worker under various exposure circumstances. As a result, the workplace environment and the management of workers' health can be improved.

### BRIEF DESCRIPTION OF THE DRAWINGS

FIG. 1 shows a circular diagram of the infrared locating member emulation test of the present invention.

FIG. 2 shows a schematic view of a laboratory layout of the present invention.

FIGS. 3 to 6 are regression analysis plots of the observation recroded values and the instrument-recorded values in zones A to D, respectively, in the laboratory layout shown in FIG. 2.

FIG. 7 is a regression analysis of the results of the automatic sampling and of the conventional sampling in the laboratory.

FIGS. 8 to 10 are regression analysis plots of the observation recroded values and the instrument-recorded values in zones X to Z, respectively, in a on-site workplace.

FIG. 11 is a regression analysis of the results of the automatic sampling and of the conventional sampling in the on-site workplace.

### DETAILED DESCRIPTION OF THE INVENTION

The present invention discloses a device for monitoring a worker's exposure pattern in a workplace, said device comprising:

an infrared locating member capable of decoding and receiving infrared rays emitted by one or more infrared rays transmitting members which are located at one or more specified locations in the workplace whereby said infrared locating member serves as a sensor for monitoring an exposure position;

a chemical sensor for monitoring an exposure concentration of a hazardous gas existing in the workplace at the exposure position of the worker; and

a controller connected to said infrared locating member and said chemical sensor for receiving an exposure position signal from said infrared locating member and an exposure concentration signal from said chemical sensor;

wherein said controller is provided with a built-in timer or an external timer connected thereto, said controller os further provided with a built-in data storage unit or an external data storage unit connected thereto.

Preferably, said controller is capable of timing and storing data.

Preferably, said controller comprises a microprocessor.

Preferably, said controller further comprises an analog-digital converter for receiving an analog signal transmitted by said infrared locating member and/or by said chemical sensor.

Preferably, said data storage unit of said controller is ROM.

Preferably, the device of the present invention further comprises a power source connected with said infrared locating member, said chemical sensor, and said controller.

The present invention also provides a method for monitoring a worker's exposure pattern in a workplace comprising continuously measuring a worker's exposure position and an exposure concentration in connection with a hazardous gas existing in the workplace at the worker's exposure position, wherein said exposure position is monitored by an infrared locating member capable of decoding and receiving infrared rays emitted by one or more infrared rays emitting members which are located at one or more specified locations of the workplace, and said exposure concentration is monitored by a chemical sensor, wherein said infrared locating member and said. chemical sensor are carried by said worker.

The present invention further discloses another method for monitoring a worker's exposure pattern in a workplace comprising continuously measuring a worker's exposure position by using an infrared locating member capable of decoding and receiving infrared rays emitted by one of more infrared rays emitting members which are located at one or more specified locations of the workplace, and obtaining an exposure concentration in connection with a hazardous gas existing in the workplace at the worker's exposure position by using premeasured exposure concentrations of said hazardous gas at various worker's exposure positions.

The infrared locating member comprises at least one infrared receiving member and one infrared decoder. The infrared receiving member is preferably provided with a single infrared rays receiving element. The infrared receiving member is preferably joined with the externally-located infrared rays emitting member to form a set, such as IRB5-43C-B (an infrared LED) and RPM6938 (an infrared rays receiving transistor). The infrared decoder is preferably an infrared decoding chip and is joined with the externally-located infrared rays emitting end, such as PT2248 and PT2249A of Princeton Technology Corp. The infrared locating member is capable of identifying the location from which the infrared rays are emitted.

The infrared rays emitting member is used in such a manner that its number is dependent on the size of the exposure site. If the exposure site is relatively small one infrared rays emitting member is sufficient.

The chemical sensor is any known chemical sensor, depending on the nature of the hazardous gas to be monitored. For example, tin dioxide semiconductor-type ethanol gas sensor may be used to monitor the hazardous gas, such as ethanol and the like.

The output signals of the infrared locating member and the chemical sensor may be digital signals or analog signals. If the output signals of the infrared locating member and the chemical sensor are analog signals, the controller must be provided with an analog-digital converter.

The controller is a microprocessor or IC. The data storage unit is RAM, EEPROM, or the like. The present invention is communicated with the externally-connected units by radio transmission. The controller is preferably a microprocessor with a data storage unit, such as Basic X-24 of NetMedia, including ADC, EEPRO, RAM, etc.

The power source of the present invention is battery.

The controller and the infrared locating member form a circuit or IC. The controller and the chemical sensor form a circuit or IC. The infrared locating member, the chemical sensor and the controller form an IC.

The monitoring method of the present invention involves a continuous measurement of an exposure position and an exposure concentration of a worker to a harmful gas existing in the worker's workplace. The infrared locating member is capable of identifying an infrared rays emitting element which is located at a specified location in the workplace. The exposure concentration is measured by the chemical sensor. The measurements are done at an interval not exceeding five minutes, preferably not exceeding one minute, 10 seconds, or 2 seconds. The measurements of the exposure location and the exposure concentration are equal in frequency such that the time difference of the location measurement and the concentration measurement is smaller than one fifth of the interval of two continuous measurements. The exposure concentration of the exposure position is the recorded exposure concentration which is a pre-measured concentration of each exposure position for a prolonged period of time, such as statistical concentration, other correction valve, or expert's estimated concentration.

The present invention is further explained by an embodiment as follows.

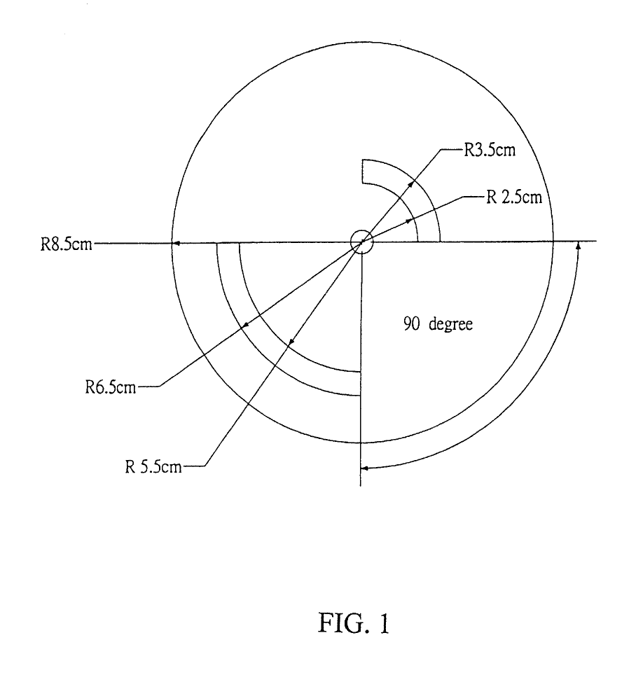

The infrared ray is used to located the workers. As a result, the instrument should be able to receive the infrared rays with precision and on real-time basis. The present invention makes use of the light obstruction mode to emulate the workers working back and forth between two working areas. The continuous switching of the infrared emission is done by the rotary disk, so as to emulate the regular change in position of the workers in various working positions. A black disk having a diameter of 30 cm is used such that a infrared emission fence with a 0.5 cm width is planned and is separated from the circle center by 15 cm and 20 cm. For details, please refer to FIG. 1. The disk is placed on a deceleration motor which is controlled by various operation voltages. The disk is provided in the margin with a tin foil attached thereto. The electronic counter, the metal sensor are used to count the revolution number of the disk. Located behind the disk are two IR transmitter with codes being 2 and 3 respectively. When the disk completes one revolution, the infrared emitted by IR LED signal is turned on and off in rotation, thereby enabling the server to receive signals for four times, with codes being 2, 0, 30. By recording the revolution number of the disk by means of electronic counter, the data batch received by the receiving end is calculated. The precision of receiving the infrared rays is determined by comparing the number of signal reception which is recorded by the instrument. For each test, the disk is turned 500 revolutions in principle.

Table 1 shows the results of testing the precision and the accuracy. In the 15 tests, the average accuracy is 99.9%. in other words, in every 1000 times of position change, there is only one judgment error. The results must satisfy the requirement of the exposure assessment in general.

In addition, the time of each position change is changed by adjusting the voltage. In the meantime, the smallest receiving time is determined by observing the sensing condition of the infrared receiver. The results show that each IR code change time is over 1.3 seconds, and that the infrared receiver can receive the signal with stability. The speed of movement of the workers in the workplace is generally within one meter per second. As long as the workers enter the measurement range, their positions can be judged quickly and then recorded.

TABLE 1
IR receiving accuracy

| | Number of time of signal reception | |
|---|---|---|
| Transmitter | [actual measurement value (time)/ | Receiving |
| code | premeasurement value (time)] | accuracy |
| #2 | 500/500 | 100.00% |
| | 516/517 | 99.81% |
| | 506/507 | 99.80% |
| | 531/531 | 100.00% |
| | 511/512 | 99.80% |
| | 517/517 | 100.00% |
| | 513/514 | 100.00% |
| | 542/543 | 99.82% |
| | 513/514 | 100.00% |
| | 514/514 | 100.00% |
| | 521/521 | 100.00% |
| | 512/513 | 99.81% |
| | 502/203 | 99.80% |
| | 513/513 | 100.00% |
| | 530/531 | 99.81% |
| #3 | 500/500 | 100.00% |
| | 517/517 | 100.00% |
| | 507/507 | 100.00% |
| | 531/531 | 100.00% |
| | 512/512 | 100.00% |
| | 517/517 | 100.00% |
| | 514/514 | 100.00% |
| | 542/543 | 100.00% |
| | 514/514 | 100.00% |
| | 514/514 | 99.81% |
| | 521/521 | 100.00% |
| | 513/513 | 100.00% |
| | 502/503 | 99.80% |
| | 513/513 | 100.00% |
| | 531/531 | 100.00% |

The present invention can be proved in the laboratory and the workplace.

i) Method and Procedures of Laboratory Dynamic Emulation Experiment

In this experiment, the locating instrument was installed in the laboratory ceiling. The researcher carried the receiver to move in the laboratory. The purpose was to emulate the environment of the workplace and to understand if the dynamic performance of the instrument was the same as expected.

The laboratory emulation experiment included two parts. The detailed method and procedure are explained as follows:

(1) Activity Pattern Recorder Dynamic Performance Test

The test is intended to understand if the personal receiving server can receive accurately the signal transmitted by the infrared transmitter. The movement data and the sampling direction switching are instantly recorded. That is to test the receiving accuracy of the infrared rays under the dynamic circumstances. The testing job is divided into the following steps:

A. Space Panning

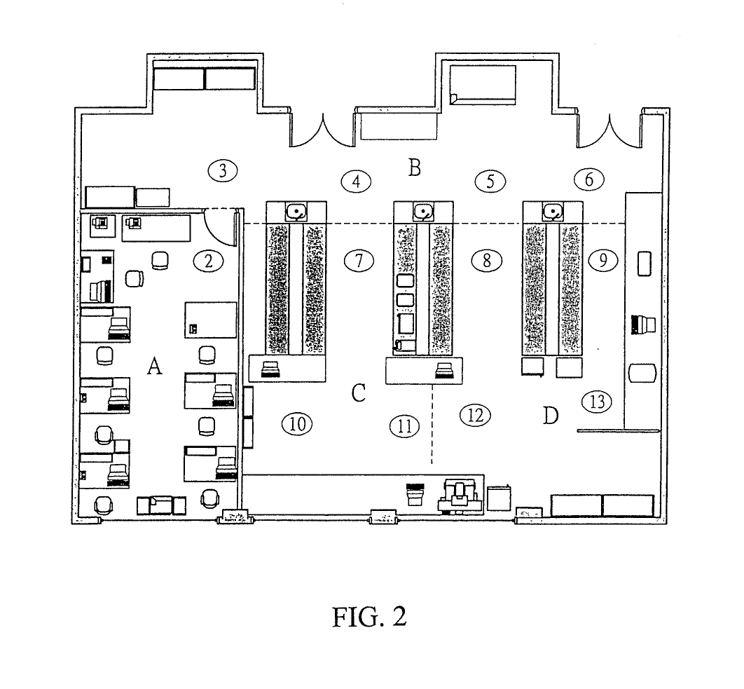

The laboratory of this test has a length of 13 meters and a width of 9 meters. The space planning is divided into B, C, D areas, in which there is a research room having a length of 7 meters and a width of 3 meters. It is planned as A area. Each area layout is shown in FIG. 2 in which the area boundaries are shown by the dotted lines.

B. Transmitter Layout

According to the laboratory space planning and the likelihood of the motion line, the laboratory is provided with 12 infrared rays transmitters, with codes of #2-#13. The researcher uses the receiver to receive the signal of each transmitting point, so as to determine if the layout position must be readjusted. The layout position and codes are shown in FIG. 2 (The circle indicates the position of the infrared ray transmission.) The number in the circle is code.

C. Dynamic Emulation Experiment

In this test, the subjects wore the soft cap with infrared receiving sensor attached thereto. The signal received was sent to the sample recording server carried around the waist. This design enables the infrared transmitter and the receiver to be devoid of any obstacle. Each subject carried simultaneously two sets of sample recorders. Each test includes two subjects. The test lasted 15-30 minutes. The test was done for a total of ten times.

The subjects were required to observe the recorder in which the entry time and the exit time of each area were recorded, so as to check with the time of the recorder. The calibrated electronic watch was used. The laboratory floor was marked with codes. Each subject was asked to record the code and the time when the subject entered an area. The time unit was second.

The experimental results of time-activity are shown in Table 2. The results recorded automatically by the instrument are indicated by “REC”. The results recorded by the subjects are denoted by “OBS”. The relative error percentage (ERR%) is calculated by the following formula.

$$ERR \% = \frac{\vert OBS - REC \vert}{OBS} \times 100 \% \qquad ( 1 )$$

From Table 2, it can be seen that the relative error percentage of A area ranges between 0 and 25.1%, with the average being 1.65% and the standard deviation being 4.15%. The relative error percentages of other areas are shown in Table 3. From Table 3, it can be seen that the largest relative error percentage is 27.01% in A, B, C, D areas, and that the smallest relative error percentage is 0% in the four areas. The average of the relative error percentages of all areas is in the range of 1.57% and 3.43%. These test results agree with the observation results. The errors might be due to the following reasons. When the subjects entered an area boundary without receiving the infrared signal, there might be an erroneous record in the instrument in the event that the subject overstayed in the area. This is main source of error. In a total of 40 tests, and in a total of 160 batches of area data, only 18 batches have a relative error greater than 5%, which is only 11.25% of the total data. The results recorded by instrument and the results recorded by the researcher are in the acceptable range.

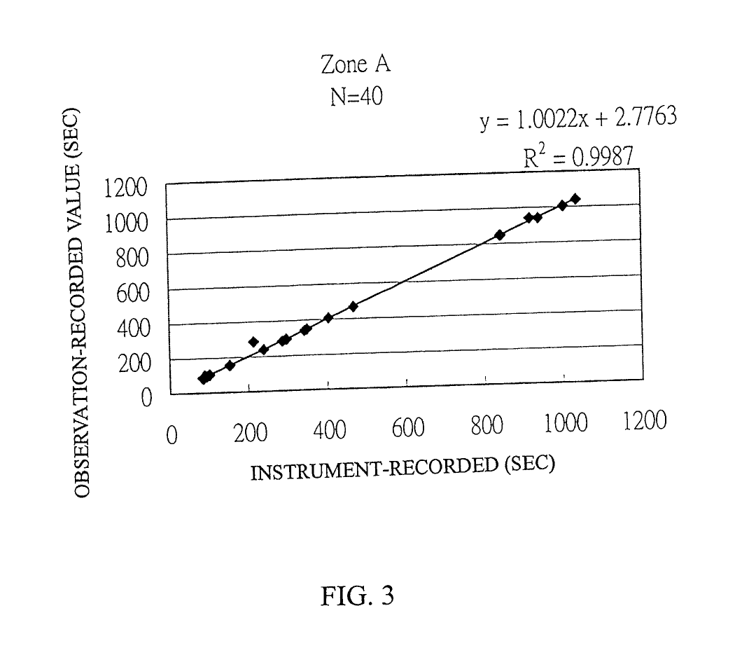

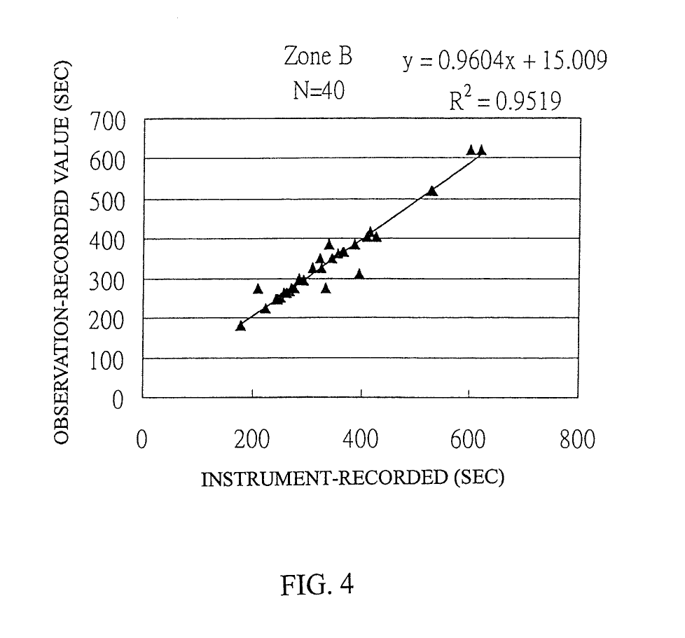

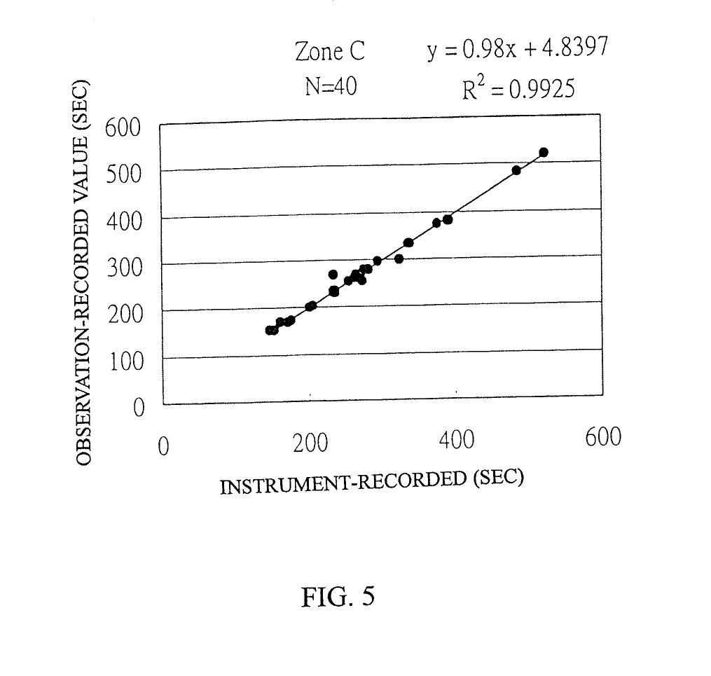

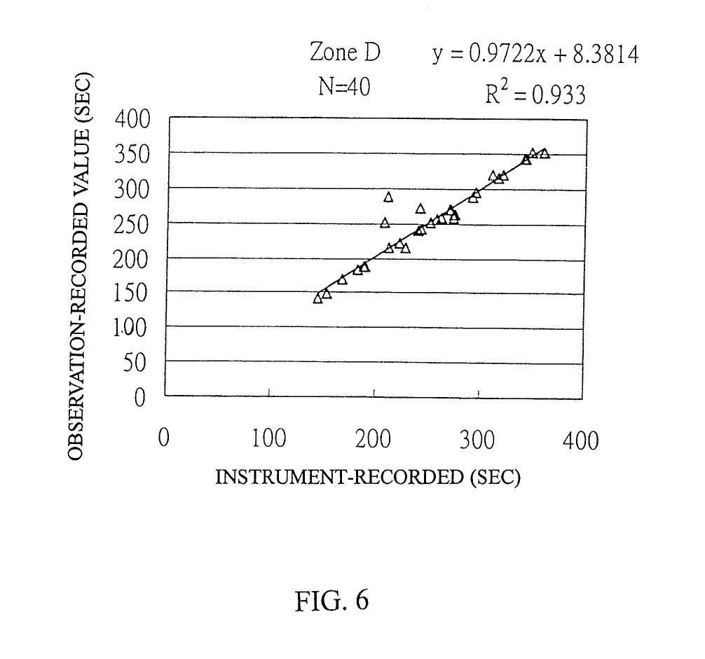

The regression analysis of the instrument results and the subject observation results is done to understand their correlation. The results are shown in FIGS. 3-6. The best correlation exists in A area and C area, with the correlation coefficient (R²) being as high as 0.99. The correlation of B area is also good, with its correlation coefficient (R²) being as high as 0.95. The area D has an obvious difference between the instrument results and the observation results, with the correlation coefficient (R²) being 0.93 or higher. In short, the infrared locating method can be used to record the time-activity pattern of the workers at the workplace.

(2) Laboratory Test of Exposure Assessment

This test proves the feasibility of the instrument in assessing the exposure to toluene. The experimental method is described hereinafter.

By means of toluene serving as the exposure material, an emulated exposure concentration is produced in the laboratory. This inventor carried the sampler to test its performance. The test items are as follows:

A. Gas Sensor Calibration

The gas sensor must be first calibrated before it is used to measure the organic gas such that the calibration curve is established with reference to five-point concentration versus voltage value. Thereafter, the calculation is done to determine the voltage signal of the instrument recording corresponding to the gas concentration at the time when the sample is taken. This is compared with the sampling value of the activated carbon tube.

The gas sensor is calibrated by a standard gas generator. The standard gas generator comprises a gas generating system, a flow control system, a humidity control system, a temperature control system, an injection system, a mixing cavity, an exposure cavity, and an exhaust fume system.

In operation, the air is pumped into the gas generating system by means of an air compressor (Air Tank, Model SF-100S, Fong Chi Co., Ltd., Taichung, Taiwan). In light of the air containing impurities and water vapor, a filtration tube (diameter of 8 cm and length of 30 cm) is added. The filtration tube is filled with the activated charcoal and the silicon rubber to remove the impurities and the moisture. The flow control system is formed of a flow controller (Hastings Inc., Virginia, U.S.A.) and a flow meter A for controlling the air flow and the total flow.

The humidity control system is used to control the flow of the dry air generated by the gas generating system such that the dry air is channeled through the exposure gas system, and that the flow of the humid air is controlled by the flow meter A. The exposure gas system makes use of two exposure gas bottles which are connected in series and are intended to give an added moisture to the air current, so as to emulate the humidity of the actual air.

The temperature control system makes use of a water bath capable of temperature control. The exposure cavity is disposed in the water bath to attain the temperature control of the gas of the exposure cavity.

The injection system comprises a syringe pump (Model 355, Orion Inc., Boston, Mass., U.S.A.). The syringe needle (Hamilton Co., Nevada, U.S.A.) is used to inject slowly the organic liquid into the heated pipe which is insulated with a heat tape. The organic liquid is evaporated to become gas, which is mixed in the mixing chamber before being guided into the exposure cavity. The mixing cavity is made of Teflon and has a diameter of 7.5 cm and a length of 14 cm. The cylindrical mixing cavity is provided therein with a stop plate for generating a turbulence. The dry air and the humid air are mixed with the organic gas before they are guided into the exposure cavity which is of a tubular construction and has a diameter of 2 cm and a length of 25 cm. The exposure cavity is provided with five holes for sampling and mounting the gas sensor. The exposure cavity is disposed in the water bath of the temperature control system to control the temperature of the exposure cavity.

The test is carried out such that the leak is tested, and that the flow meter is calibrated, and further that the injection pump is calibrated. The leak test is done by keeping the positive pressure of the system before using the soap foam to test the leak of each joint of the test pipeline. The flow meter is calibrated by the infrared soap foam flow calibrator (Gillian Inc.). The injection calibration is to check its injection rate.

B. Emulation Concentration Evaporation Area Planning

The sampling was done by means of the activated charcoal tube in the laboratory as shown in FIG. 2. According to the general workplace of the workers, the laboratory space was divided into a high concentration area, an intermediate concentration area, and a low concentration area. The laboratory was emulated as a workplace. In general, the workplace is the worker's intermediate and high exposure locations. As a result, the infrared rays transmitters were disposed in the high concentration exposure area of C area (where a tray containing toluene was placed) and the intermediate concentration areas of B area and D area. An independent space contiguous the workplace was used as a waiting room for use by the workers. The research room (A area) was assigned as the low concentration exposure area.

C. Concentration Evaporation Source Layout

The toluene was used as a volatile material such that a amount of the toluene was used to attain a maximum evaporation. In the laboratory, the aluminum tray (23×30 cm) was used to increase the evaporation area. In each experiment, two trays were used to contain 500 ml of toluene liquid and were located in the high concentration exposure area C in conjunction with a ventilation fan which was intended to avert the continuous increase in concentration. The hallways or windows of the adjoining laboratory were closed to avert the escape of the toluene gas.

D. Activated Carbon Tube Sampling

Upon completion of the layout of the evaporation source, the source was left without disturbance for 20-30 minutes to allow the diffusion. After the uniform diffusion was reached, the sample was taken with the active carbon tube. The standard active carbon tube (SKC226-01) was used as a sampling medium. The low flow sampling pump (Model LFS113D, Gilian Corp., U.S.A.) was used as pumping power source which was connected to two ends of the flow control module, so as to carry out the active sampling. Each set of sample recorder and the flow control module were simultaneously connected with three active carbon tubes for sampling the high, the intermediate, and the low concentration exposures. In the experiment, each subject carried two sets of sample recorders to carry out two repeated sampling chores, and one set of the conventional active sampler for comparison. Before and after each experiment, the flow rate of the sampling pump was calibrated with the infrared foam flow meter. The flow of the sampling pump was set at 100 ml/min. The sampling time lasted about one hour. In the sampling process, each subject was required to observe and record TAP data for comparison with the data recorded by the instrument. The samples were kept in the Teflon container, which was sealed off with paraffin and was fept in the refrigerator in the laboratory.

E. Sample Analysis

The sample analysis was done according to the Taiwan government regulation No. 1235 in conjunction with GC/FID. The analysis method and steps are described hereinafter.

1. Quantitative Inspection Line Layout

The chromatography-grade toluene and carbon disulfide were used to prepare the standard solutions of five different concentrations to establish the quantitative inspection line of the GC analysis. The concentration range is 8.66 mg/L˜103.92 mg/L).

2. Sample Desorption

The sampled active carbon was placed in a 2 ml-vial into which the desorbent of carbon disulfide was added. The oscillator was used to shake it for about 2 hours before the desorbed product being analyzed.

3. GC Analysis Condition

The sample collected by this research institute was analyzed by GC(HP5890 AII), FID tube, with carrier gas being nitrogen. In analysis, the injector was set at 200° C. The detector was set at 250° C. The oven was set at 45° C. The lower limit of the integrating instrument was set at 10000.

Table 4 contains the results of personal exposure assessment emulation experiment conducted in the laboratory. The “TWA-N” concentration of the Table 4 was calculated by using the formula as follow:

$$TWA \text{-} N = \frac{{C}_{L} \times {T}_{L} + {C}_{M} \times {T}_{M} + {C}_{H} \times {T}_{H}}{{T}_{Total}} , in which TWA \text{-} N \qquad ( 2 )$$

stands for the average concentration (mg/m³) calculated according to the sampling time of individual sampling tube; C_{L}, the air concentration (mg/m³) of the low concentration zone recorded by the automatic sampling recorder; C_{M}, the air concentration (mg/m³) of the intermediate concentration zone recorded by the automatic sampling recorder; C_{H}, the air concentration of the high concentration zone recorded by the automatic sampling recorder; T_{L}, the staying time (sec.) of the low concentration zone recorded by the automatic sampling recorder; T_{M}, the staying time (sec.) of the intermediate concentration zone recorded by the automatic sampling recorder; T_{H}, the staying time of the high concentration zone recorded by the automatic sampling recorder; and T_{Total}, the sum of sampling time (sec.)

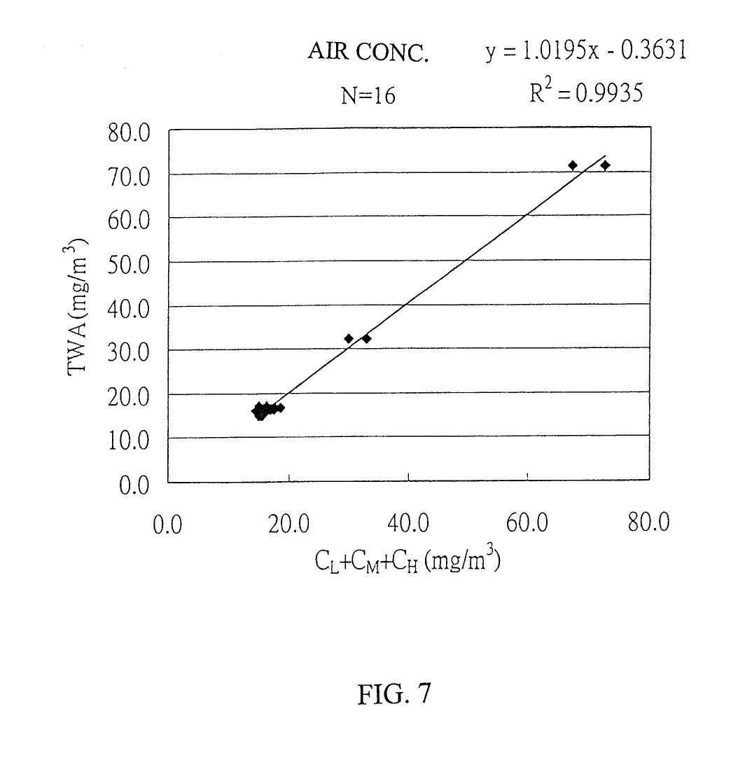

The TWA-N concentration was compared with the air concentration obtained by the conventional integrating sampling method (TWA), the relative error was in the range of 1.65-11.12%, with the average relative error being 5.62%. The result of pair T-test showed that there was no apparent difference (p=0.7) between the result of the automatic sampling and the result of the conventional sampling. The regression analysis of these results was done. The result is shown in FIG. 7 in which the correlation is shown to be as high as 0.99 (R²=0.99).

In terms of time activity, the results of the laboratory test of the present invention show no apparent difference with the results obtained by the naked eye observations. In addition, the sampling of the exposure assessment of the present invention shows no difference from the conventional method.

TABLE 2
Time-activity test results (laboratory)

| A Zone | | | B Zone | | | C Zone | | | D Zone | | | Total | | | Labor- |
|---|---|---|---|---|---|---|---|---|---|---|---|---|---|---|---|
| Time (sec) | | Error | Time (sec) | | Error | Time (sec) | | Error | Time (sec) | | Error | Time (sec) | | Error | atory |
| Rec. | Obs. | (%) | Rec. | Obs. | (%) | Rec. | Obs. | (%) | Rec. | Obs. | (%) | Rec. | Obs. | (%) | no.# |
| 285 | 286 | 0.35 | 275 | 274 | 0.36 | 205 | 204 | 0.49 | 183 | 182 | 0.55 | 948 | 946 | 0.21 | 1 |
| 468 | 468 | 0.00 | 178 | 179 | 0.56 | 174 | 175 | 0.57 | 241 | 240 | 0.42 | 1061 | 1062 | 0.09 | 2 |
| 239 | 240 | 0.42 | 270 | 276 | 2.17 | 281 | 279 | 0.72 | 292 | 288 | 1.39 | 1082 | 1083 | 0.09 | 3 |
| 153 | 154 | 0.65 | 387 | 386 | 0.26 | 255 | 255 | 0.00 | 321 | 320 | 0.31 | 1115 | 1115 | 0.00 | 4 |
| 214 | 286 | 25.17 | 334 | 274 | 21.90 | 205 | 204 | 0.49 | 183 | 182 | 0.55 | 948 | 946 | 0.21 | 5 |
| 468 | 468 | 0.00 | 178 | 179 | 0.56 | 174 | 175 | 0.57 | 241 | 240 | 0.42 | 1061 | 1062 | 0.09 | 6 |
| 239 | 240 | 0.42 | 208 | 276 | 24.64 | 274 | 279 | 1.79 | 211 | 288 | 26.74 | 1082 | 1083 | 0.09 | 7 |
| 154 | 154 | 0.00 | 341 | 386 | 11.66 | 273 | 255 | 7.06 | 310 | 320 | 3.13 | 1114 | 1115 | 0.09 | 8 |
| 94 | 94 | 0.00 | 325 | 328 | 0.91 | 201 | 200 | 0.50 | 317 | 315 | 0.63 | 937 | 937 | 0.00 | 9 |
| 89 | 98 | 9.18 | 395 | 311 | 27.01 | 234 | 269 | 13.01 | 242 | 273 | 11.36 | 979 | 951 | 2.94 | 10 |
| 83 | 84 | 1.19 | 368 | 366 | 0.55 | 374 | 376 | 0.53 | 258 | 257 | 0.39 | 1083 | 1083 | 0.00 | 11 |
| 102 | 101 | 0.99 | 346 | 349 | 0.86 | 234 | 232 | 0.86 | 252 | 251 | 0.40 | 934 | 933 | 0.11 | 12 |
| 95 | 94 | 1.06 | 326 | 328 | 0.61 | 200 | 200 | 0.00 | 317 | 315 | 0.63 | 938 | 937 | 0.11 | 13 |
| 88 | 87 | 1.15 | 414 | 415 | 0.24 | 234 | 233 | 0.43 | 243 | 242 | 0.41 | 979 | 977 | 0.20 | 14 |
| 83 | 84 | 1.19 | 366 | 366 | 0.00 | 375 | 376 | 0.27 | 258 | 257 | 0.39 | 1082 | 1083 | 0.09 | 15 |
| 102 | 101 | 0.99 | 323 | 349 | 7.45 | 236 | 232 | 1.72 | 208 | 251 | 17.13 | 933 | 933 | 0.00 | 16 |
| 341 | 343 | 0.58 | 256 | 263 | 2.66 | 146 | 153 | 4.58 | 274 | 258 | 6.20 | 1017 | 1017 | 0.00 | 17 |
| 404 | 410 | 1.46 | 222 | 223 | 0.45 | 294 | 296 | 0.68 | 145 | 141 | 2.84 | 1070 | 1070 | 0.00 | 18 |
| 348 | 350 | 0.57 | 294 | 294 | 0.00 | 265 | 269 | 1.49 | 154 | 149 | 3.36 | 1061 | 1062 | 0.09 | 19 |
| 295 | 294 | 0.34 | 244 | 246 | 0.81 | 234 | 234 | 0.00 | 223 | 222 | 0.45 | 996 | 996 | 0.00 | 20 |
| 341 | 343 | 0.58 | 262 | 263 | 0.38 | 152 | 153 | 0.65 | 262 | 258 | 1.55 | 1017 | 1017 | 0.00 | 21 |
| 404 | 410 | 1.46 | 222 | 223 | 0.45 | 294 | 296 | 0.68 | 145 | 141 | 2.84 | 1070 | 1070 | 0.00 | 22 |
| 349 | 350 | 0.42 | 294 | 294 | 0.42 | 265 | 269 | 0.42 | 154 | 149 | 0.42 | 1062 | 1062 | 0.00 | 23 |
| 294 | 294 | 0.00 | 242 | 246 | 1.63 | 236 | 234 | 0.85 | 223 | 222 | 0.45 | 995 | 996 | 0.10 | 24 |
| 84 | 83 | 1.20 | 252 | 253 | 0.40 | 337 | 334 | 0.90 | 269 | 270 | 0.37 | 942 | 940 | 0.21 | 25 |
| 83 | 86 | 3.49 | 310 | 328 | 5.49 | 322 | 300 | 7.33 | 294 | 295 | 0.34 | 1009 | 1009 | 0.00 | 26 |
| 102 | 102 | 0.00 | 268 | 267 | 0.37 | 263 | 263 | 0.00 | 342 | 343 | 0.29 | 975 | 975 | 0.00 | 27 |
| 101 | 101 | 0.00 | 285 | 297 | 4.04 | 270 | 268 | 0.75 | 274 | 263 | 4.18 | 930 | 929 | 0.11 | 28 |
| 86 | 83 | 3.61 | 251 | 253 | 0.79 | 335 | 334 | 0.30 | 271 | 270 | 0.37 | 943 | 940 | 0.32 | 29 |
| 83 | 86 | 3.49 | 310 | 328 | 5.49 | 322 | 300 | 7.33 | 294 | 295 | 0.34 | 1009 | 1009 | 0.00 | 30 |
| 101 | 102 | 0.98 | 267 | 267 | 0.00 | 264 | 263 | 0.38 | 343 | 343 | 0.00 | 975 | 975 | 0.00 | 31 |
| 101 | 101 | 0.99 | 284 | 297 | 0.99 | 270 | 268 | 0.99 | 275 | 263 | 0.99 | 930 | 929 | 0.11 | 32 |
| 1037 | 1040 | 0.288 | 600 | 620 | 3.226 | 391 | 383 | 2.089 | 229 | 214 | 7.009 | 2257 | 2257 | 0.000 | 33 |
| 1004 | 1005 | 0.100 | 357 | 361 | 1.108 | 522 | 521 | 0.192 | 190 | 187 | 1.604 | 2073 | 2074 | 0.048 | 34 |
| 1037 | 1040 | 0.288 | 618 | 620 | 0.323 | 390 | 383 | 1.828 | 212 | 214 | 0.935 | 2257 | 2257 | 0.000 | 35 |
| 1005 | 1005 | 0.000 | 356 | 361 | 1.385 | 523 | 521 | 0.384 | 189 | 187 | 1.070 | 2073 | 2074 | 0.048 | 36 |
| 845 | 848 | 0.354 | 526 | 520 | 1.154 | 171 | 169 | 1.183 | 349 | 351 | 0.570 | 1891 | 1892 | 0.053 | 37 |
| 940 | 941 | 0.106 | 410 | 407 | 0.737 | 486 | 485 | 0.206 | 168 | 169 | 0.592 | 2004 | 2002 | 0.100 | 38 |
| 843 | 848 | 0.417 | 529 | 520 | 0.417 | 160 | 169 | 0.417 | 360 | 351 | 0.417 | 1892 | 1892 | 0.000 | 39 |
| 919 | 941 | 2.338 | 426 | 407 | 4.668 | 486 | 485 | 0.206 | 169 | 169 | 0.000 | 2003 | 2002 | 0.050 | 40 |

TABLE 3
time-activity test results (laboratory)
error(%) = (Obs.-Rec.)/Obs * 100%

| | A Zone | B Zone | C Zone | D Zone | Total |
|---|---|---|---|---|---|
| Average error | 1.65 | 3.43 | 1.57 | 2.55 | 0.14 |
| Mininum error | 0.00 | 0.00 | 0.00 | 0.00 | 0.00 |
| Maximum error | 25.17 | 27.01 | 13.01 | 26.74 | 2.94 |
| Standard deviation | 4.15 | 6.55 | 2.65 | 5.15 | 0.46 |

TABLE 4
Results of Laboratory Emulation Exposure Test

| | Air concentration | | |
|---|---|---|---|
| Experiment | TWA-N | TWA | Relative error |
| # | (mg/m³) | (mg/m³) | (%) |
| 1 | 17.501 | 16.226 | 7.557 |
| 2 | 16.725 | 16.226 | 3.024 |
| 3 | 16.321 | 16.838 | 3.119 |
| 4 | 15.064 | 16.838 | 11.122 |
| 5 | 15.120 | 16.384 | 8.028 |
| 6 | 17.093 | 16.384 | 4.236 |
| 7 | 14.428 | 16.041 | 10.589 |
| 8 | 16.307 | 16.041 | 1.649 |
| 9 | 15.496 | 14.684 | 5.380 |
| 10 | 15.071 | 14.684 | 2.605 |
| 11 | 17.615 | 16.751 | 5.028 |
| 12 | 18.662 | 16.751 | 10.792 |
| 13 | 33.038 | 32.093 | 2.901 |
| 14 | 30.061 | 32.093 | 6.539 |
| 15 | 67.340 | 71.159 | 5.515 |
| 16 | 72.537 | 71.159 | 1.917 |

ii. on-site test experimental method and steps:

(1) Description of Conditions of Workplace

The test was conducted in the factory of a plastic tape company. The main hazardous gas at the factory is toluene.

The details of the workplace are described hereinafter.

A. Working Location

The staying locations of the workers include the waiting room and the working area which has four assembly lines. In each assembly line, there is one machine operator whose working areas include a preparation area, a bottom plastic area, a bottom plastic area, a face plastic area, an aisle, and the waiting room. The workers spend most of their time in the preparation area. The highest exposure concentration takes place in the bottom plastic area and the face plastic area.

B. Working Hours and Working Schedule

The workers are required to report to work according to the work schedule. The workers assigned to the specific machine were recorded in details. The workers were allowed to take a break in the waiting room.

C. Working Types

The worker's responsibity includes coating tape, connecting tape, inspecting bottom tape, inspecting face tape, etc. The worker prepares first at the preparation area until such time when one roll of cloth is finished. Upon completion of lifting the cloth and lowering the cloth, there is an interval during which the worker must inspect the coating of bottom plastic and the face plastic. The rear section of the production line is provided with an inspector who inspects the specification of the product. When there is a defective product, the alarm is sounded to remind the worker to inspect the assembly line.

(2) Workplace Exposure Assessment

A. Sampling Basic Data

a. sampling target:

four workers of the plastic company as an investigation reference.

b. sampling method: samples were taken three time every two days, with each sampling being carried out in the morning and the afternoon, which lasted 120 minutes respectively.

c. Workplace layout and infrared layout

A total of 20 areas was planned according to the worker's activity line and the exposure concentrations, which were divided into three areas: high, intermediate and low concentration areas.

(3) Workplace Sampling Method

This inventor of the present invention carried this system along with the active sampler, so as to carry out the sampling in a surveillance manner. The sampling was recorded. The time at which the entry of the area took place was recorded. The sampling steps are described as follows:

A. Active Sampling

The active sampling was carried out by means of the SKC226-01 (100 mg/50 mg) active charcoal sampling tube, the Gilian (Model LFS 113D, Group., U.S.A.) low flow personal air sampler, with sampling flow being set at 50 c.c./min. Before sampling, the flow rate was calibrated by the infrared foam flow meter. At the end of sampling, the flow was checked once again and recorded. The value difference before and after the sampling was not allowed to be greater than the average value of the two by 5%.

B. The Storage of Sample and Analysis

The sample collected was immediately sealed off by the Teflon cover and paraffin before being kept in the refrigerated container. The active carbon tube was analyzed by a Taiwan research institute laboratory. By using the toluene as a releasing agent, the carbon disulfide was released from the sampling medium. The analysis was done by GC/FID in accordance with the analysis method (#1102) of the Taiwan Government.

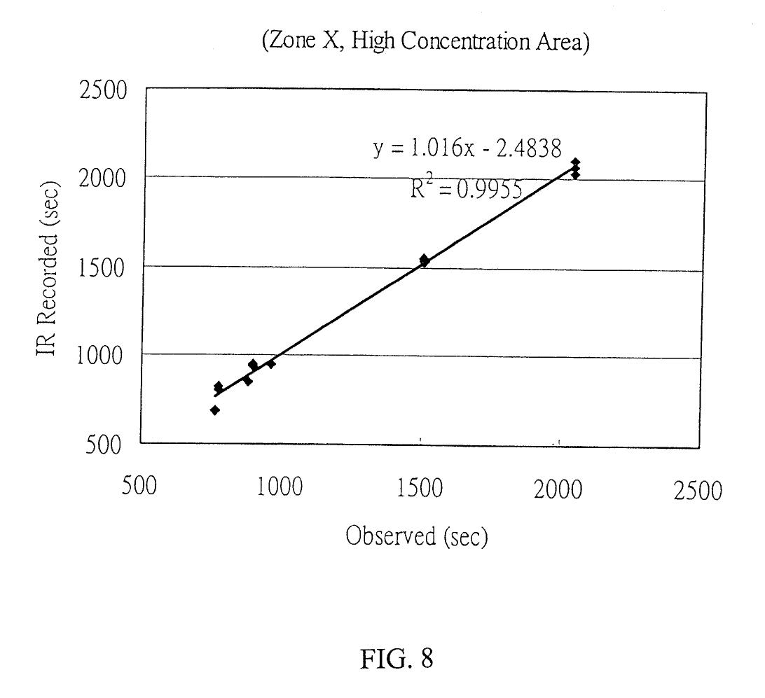

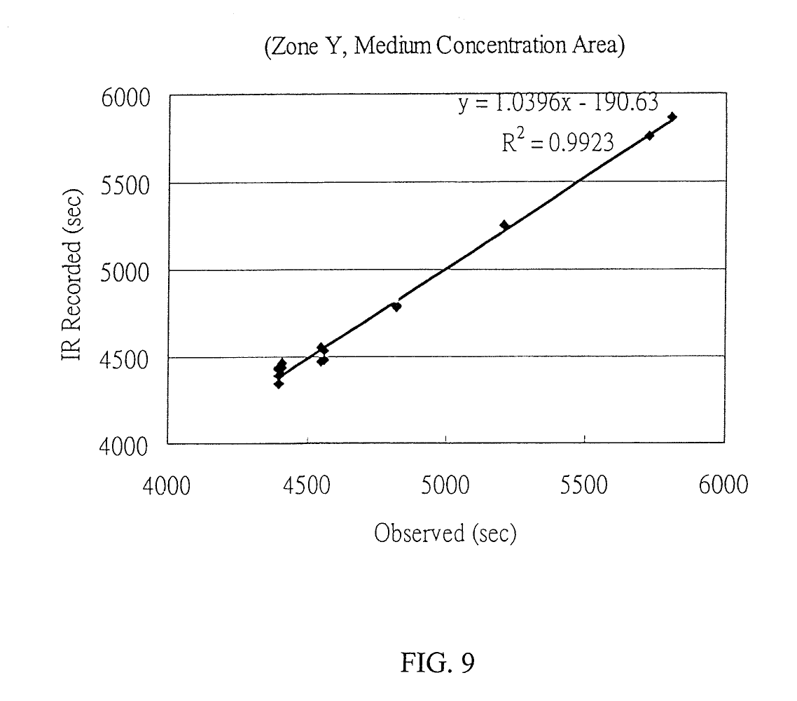

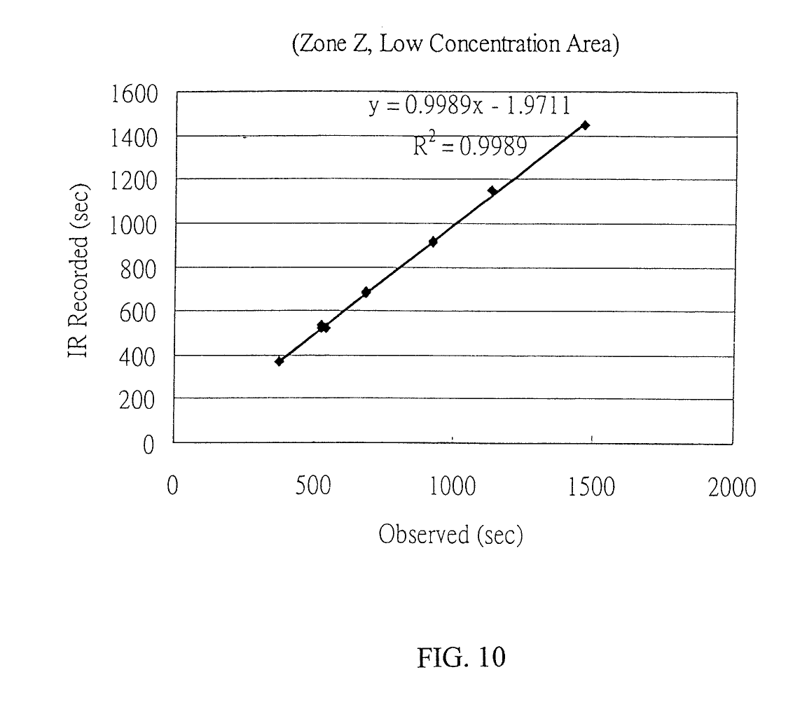

The time-activity results are contained in Table 5. The results recorded by instruments are denoted by “REC”. The results recorded by the subjects are denoted by “OBS”. The workplace was divided into X zone, Y zone, and Z zone in accordance with the high, the intermediate, and the low concentrations. The greatest relative error of two methods of the three zones way only 11.1%, with the smallest being 0.1%. The instrument-recorded value of each zone and the observation value were analyzed by regression analysis, so as to understand their correlation. The results are shown in FIGS. 8-10. The results show an excellent correlation. The correlation coefficient (R²) of individual zone is 0.99 or higher. This is a proof that the instrument is capable of recording precisely the time and the location.

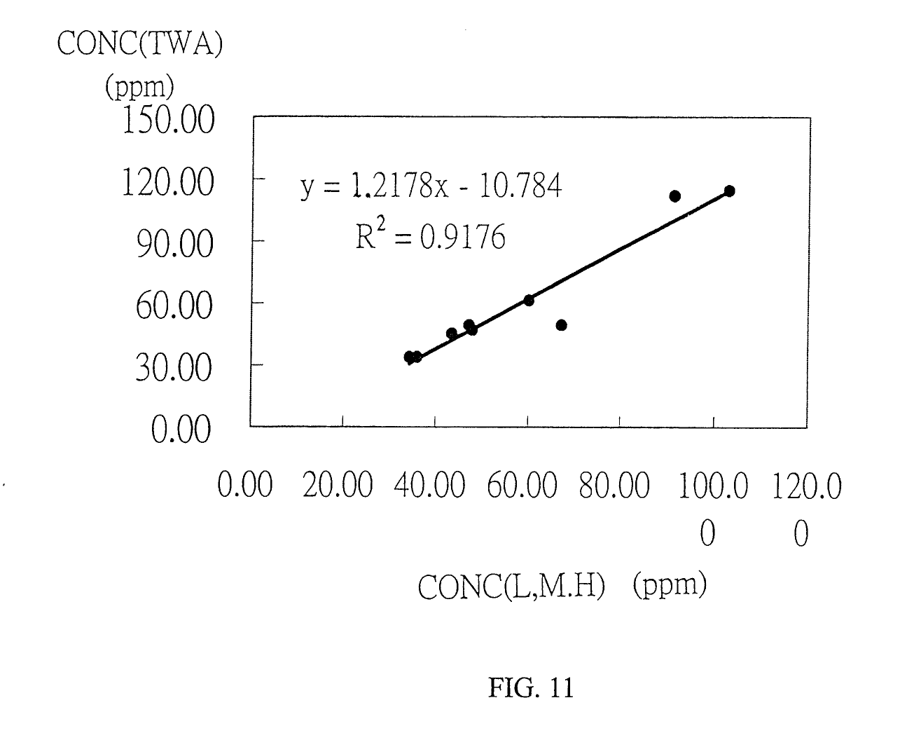

The analysis of the concentration was done by using 11 samples of the workplace exposure assessment emulation experiment. The results are contained in Table 6. The C_{L}, C_{M}, C_{H} concentrations obtained by the automatic sampler were used to calculate according to formula (2) to come out with the exposure average concentration (TWA-N), which was compared with the exposure average concentration (TWA) obtained by the conventional integrating sampling method. The maximum relative error was 36.4%, with the minimum relative error being 1.1% and with the average relative error being 8.2%. Assuming that there is no difference between the two sampling methods, and that the test is done by the pair-t test, the results suggest that the hypothesis (p>0.05) can not be statistically excluded. This means that there is in fact no difference between the two methods. As shown in FIG. 11, the regression analysis of the two was done to show that there is a high correlation (R²=0.91) between the two methods.

The effective data of this research are not numerous. Regardless of this fact, the exposure assessment of this system coincides with the conventional TWA assessment results. This system of the present invention is capable of providing more precise data with reference to the worker's working location, the worker's staying time, and the corresponding concentration. The present invention merits further development.

TABLE 5
time-activity test results (on-site tests)

| | X zone | | | Y zone | | | Z zone | | | Total | | |
|---|---|---|---|---|---|---|---|---|---|---|---|---|
| Experiment | Time(sec) | | Error | Time(sec) | | error | Time(sec) | | error | Time(sec) | | Error |
| symbol | Rec | Obs | (%) | Rec | Obs | (%) | Rec | Obs | (%) | Rec | Obs | (%) |
| 02A | 374 | 371 | 0.81 | 5807 | 5862 | 0.94 | 879 | 851 | 3.29 | 7060 | 7084 | 0.34 |
| 03A | 525 | 523 | 0.38 | 4561 | 4475 | 1.92 | 2039 | 2060 | 1.02 | 7125 | 7058 | 0.95 |
| 04A | 540 | 520 | 3.85 | 4552 | 4549 | 0.07 | 2037 | 2029 | 0.39 | 7129 | 7098 | 0.44 |
| 05A | 1127 | 1150 | 2.00 | 5206 | 5256 | 0.95 | 763 | 687 | 11.06 | 7096 | 7093 | 0.04 |
| 06A | 374 | 372 | 0.54 | 5726 | 5760 | 0.59 | 960 | 949 | 1.16 | 7060 | 7081 | 0.30 |
| 07A | 525 | 536 | 2.05 | 4561 | 4533 | 0.62 | 2039 | 2057 | 0.88 | 7125 | 7126 | 0.01 |
| 08A | 540 | 520 | 3.85 | 4552 | 4466 | 1.93 | 2037 | 2099 | 2.95 | 7129 | 7085 | 0.62 |
| 01P | 1458 | 1446 | 0.83 | 4397 | 4435 | 0.86 | 775 | 802 | 3.37 | 6630 | 6683 | 0.79 |
| 02P | 922 | 910 | 1.32 | 4816 | 4787 | 0.61 | 892 | 950 | 6.11 | 6630 | 6647 | 0.26 |
| 03P | 685 | 688 | 0.44 | 4394 | 4341 | 1.22 | 1509 | 1542 | 2.14 | 6588 | 6571 | 0.26 |
| 04P | 683 | 685 | 0.29 | 4408 | 4428 | 0.45 | 1504 | 1552 | 3.09 | 6595 | 6665 | 1.05 |
| 05P | 1458 | 1447 | 0.76 | 4397 | 4419 | 0.50 | 775 | 820 | 5.49 | 6630 | 6686 | 0.84 |
| 06P | 922 | 919 | 0.33 | 4816 | 4789 | 0.56 | 892 | 937 | 4.80 | 6630 | 6645 | 0.23 |
| 07P | 685 | 688 | 0.44 | 4394 | 4384 | 0.23 | 1509 | 1534 | 1.63 | 6588 | 6606 | 0.27 |
| 08P | 683 | 684 | 0.15 | 4408 | 4460 | 1.17 | 1504 | 1529 | 1.64 | 6595 | 6673 | 1.17 |

In the course of the long-term research carried out by this inventor of the present invention, this invention has discovered the following facts.

1. The sampling was carried out in conjunction with two sets of 8 nickel-hydrogen storage batteries. The monitoring time lasts as long as 13 hours.

2. The linear transmission range of the infrared ray transmitter reaches as far as 15M, with the transmission diameter reaching two meters or greater.

3. The experimental results of the laboratory show that the judgment precision of the present invention with regard to the infrared codes can reach 99.8% or higher, with the judgment process being completed in less than one second.

4. The laboratory test results suggest that the worker's staying time recorded by the instrument and the worker's staying time recorded by the naked eye observation have a correlation of 98 percent or higher, and that the instrumental recording can be used in place of the human observation.

5. The experimental exposure data of the workers show that the worker's exposure concentration measured instrumentally is corresponding to that which is measured by the conventional integrating sampling method.

6. The on-site test results show that the worker's staying time recorded instrumentally and the worker's staying time recorded by the researcher's observation have a correlation of 99% or higher, and that the instrument of the present invention is suitable for use in measuring the worker's activity pattern in the workplace, and further that the instrument method can be used in place of the observation method.

7. The on-site test results show that the worker's exposure concentration measured instrumentally is corresponding to that which is measured by the conventional integrating sampling method.

The present invention described above is to be regarded in all respects as being illustrative and nonrestrictive. Accordingly, the present invention may be embodied in other specific forms without deviating from the spirit thereof. The present invention is therefore to be limited only by the scopes of the following claims.

What is claimed is:

1. A device for monitoring a worker's exposure pattern in a workplace, said device comprising:
an infrared locating member capable of decoding and receiving infrared rays emitted by one or more infrared rays transmitting members which are located at one or more specified locations in the workplace whereby said infrared locating member serves as a sensor for monitoring an exposure position;
a chemical sensor for monitoring an exposure concentration of a hazardous gas existing in the workplace at the exposure position of the worker; and
a controller connected to said infrared locating member and said chemical sensor for receiving an exposure position signal from said infrared locating member and an exposure concentration signal from said chemical sensor;
wherein said controller is provided with a built-in timer or an external timer connected thereto, said controller os further provided with a built-in data storage unit or an external data storage unit connected thereto.

2. The device as defined in claim 1, wherein said controller is capable of timing and storing data.

3. The device as defined in claim 2, wherein said controller comprises a microprocessor.

4. The device as defined in claim 3, wherein said controller further comprises an analog-digital converter for receiving an analog signal transmitted by said infrared locating member and/or by said chemical sensor.

5. The device as defined in claim 1, wherein said data storage unit of said controller is ROM.

6. The device as defined in claim 1 further comprising a power source connected with said infrared locating member, said chemical sensor, and said controller.

7. A method for monitoring a worker's exposure pattern in a workplace comprising continuously measuring a worker's exposure position and an exposure concentration in connection with a hazardous gas existing in the workplace at the worker's exposure position, wherein said exposure position is monitored by an infrared locating member capable of decoding and receiving infrared rays emitted by one or more infrared rays emitting members which are located at one or more specified locations of the workplace, and said exposure concentration is monitored by a chemical sensor, wherein said infrared locating member and said. chemical sensor are carried by said worker.

8. A method for monitoring a worker's exposure pattern in a workplace comprising continuously measuring a worker's exposure position by using an infrared locating member capable of decoding and receiving infrared rays emitted by one of more infrared rays emitting members which are located at one or more specified locations of the workplace, and obtaining an exposure concentration in connection with a hazardous gas existing in the workplace at the worker's exposure position by using premeasured exposure concentrations of said hazardous gas at various worker's exposure positions.
